(19) United States
(12) Patent Application Publication
(10) Pub. No.: US 2011/0035804 A1
(43) Pub. Date: Feb. 10, 2011

(54) Appliance-based parallelized analytics of data auditing events

(76) Inventor: Pratyush Moghe, Acton, MA (US)

Correspondence Address: LAW OFFICE OF DAVID H. JUDSON, 15950 DALLAS PARKWAY, SUITE 225, DALLAS, TX, 75248, US

(21) Appl. No.: 12/755,996

(22) Filed: Apr. 7, 2010

Related U.S. Application Data
(60) Provisional application No. 61/167,422, filed on Apr. 7, 2009.
(60) Provisional application No. 61/167,426, filed on Apr. 7, 2009.

(51) Int. Cl. G06F 21/00

(52) U.S. Cl. 726/26

(57) ABSTRACT

Data auditing involves capturing, filtering, processing and analytics of real-time data transactions. As such, data auditing imposes a heavy burden of processing in the fast path, which cannot afford to slow down. Unfortunately, most processing incurred in traditional data auditing fast paths has been serial, leading to bottlenecks or scaling issues. This disclosure addresses this problem by developing a fast path where both lower and upper stacks of data auditing are analyzed and exploited for potential parallelism. A fully-parallelized analytics fast path could deliver 25-200% speed-up of throughput relative to a serial fast path, depending on the specific conditions.

### CROSS-REFERENCE TO RELATED APPLICATIONS

This application is based on Ser. No. 61/167,422, filed Apr. 7, 2009. This application also is related to Ser. No. 10/750,070, filed Sep. 24, 2004.

### BACKGROUND OF THE INVENTION

1. Technical Field

The subject matter herein relates generally to real-time monitoring, auditing and protection of information assets in enterprise repositories such as databases, file servers, web servers and application servers.

2. Description of the Related Art

“Insider” intrusions are damaging to enterprises and cause significant corporate risk of different forms including: brand risk, corporate trade secret disclosure risk, financial risk, legal compliance risk, and operational and productivity risk. Indeed, even the specification of an insider intrusion creates challenges distinct from external intrusions, primarily because such persons have been authenticated and authorized to access the devices or systems they are attacking. Industry analysts have estimated that insider intrusions have a very high per incident cost and in many cases are significantly more damaging than external intrusions by unauthorized users. As such, it is critical that if an insider intrusion is detected, the appropriate authorities must be alerted in real-time and the severity of the attack meaningfully conveyed. Additionally, because users who have complete access to the system carry out insider intrusions, it is important to have a mitigation plan that can inhibit further access once an intrusion is positively identified.

Classically, intrusion detection has been approached by classifying misuse (via attack signatures), or via anomaly detection. Various techniques used for anomaly detection include systems that monitor packet-level content and analyze such content against strings using logic-based or rule-based approaches. A classical statistical anomaly detection system that addressed network and system-level intrusion detection was an expert system known as IDES/NIDES. In general, statistical techniques overcome the problems with the declarative problem logic or rule-based anomaly detection techniques. Traditional use of anomaly detection of accesses is based on comparing sequence of accesses to historical learned sequences. Significant deviations in similarity from normal learned sequences can be classified as anomalies. Typical similarity measures are based on threshold-based comparators or non-parametric clustering classification techniques such as Hidden Markov models. While these known techniques have proven useful, content-based anomaly detection presents a unique challenge in that the content set itself can change with time, thus reducing the effectiveness of such similarity-based learning approaches.

It is also known that so-called policy languages have been used to specify FCAPS (fault-management, configuration, accounting, performance, and security) in network managements systems. For example, within the security arena, policy languages sometimes are used to specify external intrusion problems. These techniques, however, have not been adapted for use in specifying, monitoring, detecting and ameliorating insider intrusions.

In typical access management, it is also known that simple binary matching constructs have been used to characterize authorized versus unauthorized data access (e.g., “yes” if an access request is accompanied by the presence of credentials and “no” in their absence). In contrast, and as noted above, insider intrusions present much more difficult challenges because, unlike external intrusions where just packet-level content may be sufficient to detect an intrusion, an insider intrusion may not be discoverable absent a more holistic view of a particular data access. Thus, for example, generally it can be assumed that an insider has been authenticated and authorized to access the devices and systems he or she is attacking; thus, unless the behavioral characteristics of illegitimate data accesses can be appropriately specified and behavior monitored, an enterprise may have no knowledge of the intrusion let alone an appropriate means to address it.

U.S. Pat. No. 7,415,719 issued to Moghe et al, describes a method, system and appliance-based solution that enables an enterprise to specify an insider attack and to respond to that attack. The subject matter herein is an enhancement to that approach.

### BRIEF SUMMARY

Data auditing involves capturing, filtering, processing and analytics of real-time data transactions. As such, data auditing imposes a heavy burden of processing in the fast path, which cannot afford to slow down. Unfortunately, most processing incurred in traditional data auditing fast paths has been serial, leading to bottlenecks or scaling issues. This disclosure addresses this problem by developing a fast path where both lower and upper stacks of data auditing are analyzed and exploited for potential parallelism. A fully-parallelized analytics fast path could deliver 25-200% speed-up of throughput relative to a serial fast path, depending on the specific conditions.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 illustrates a representative enterprise computing environment and a representative placement of a network-based appliance that facilitates the parallelized analytics of the present invention;

FIG. 2 is a block diagram illustrating the monitoring and analytics layers of the appliance shown in FIG. 1;

FIG. 3 is a block diagram illustrating a data auditing fast path implemented in the appliance shown in FIG. 1; and

FIG. 4 is a block diagram illustrating a parallelized data auditing stack according to an embodiment of this invention.

### DETAILED DESCRIPTION OF AN EMBODIMENT

As used herein, and by way of background, an “insider” is an enterprise employee, agent, consultant or other person (whether a human being or an automated entity operating on behalf of such a person) who is authorized by the enterprise to access a given network, system, machine, device, program, process, or the like, and/or one such entity who has broken through or otherwise compromised an enterprise's perimeter defenses and is posing as an insider. More generally, an “insider” can be thought of a person or entity (or an automated routine executing on their behalf) that is “trusted” (or otherwise gains trust, even illegitimately) within the enterprise. An “enterprise” should be broadly construed to include any entity, typically a corporation or other such business entity, that operates within a given location or across multiple facilities, even worldwide. Typically, an enterprise in which the distributed search/audit and analytics features of the present invention is implemented operates a distributed computing environment that includes a set of computing-related entities (systems, machines, servers, processes, programs, libraries, functions, or the like) that facilitate information asset storage, delivery and use.

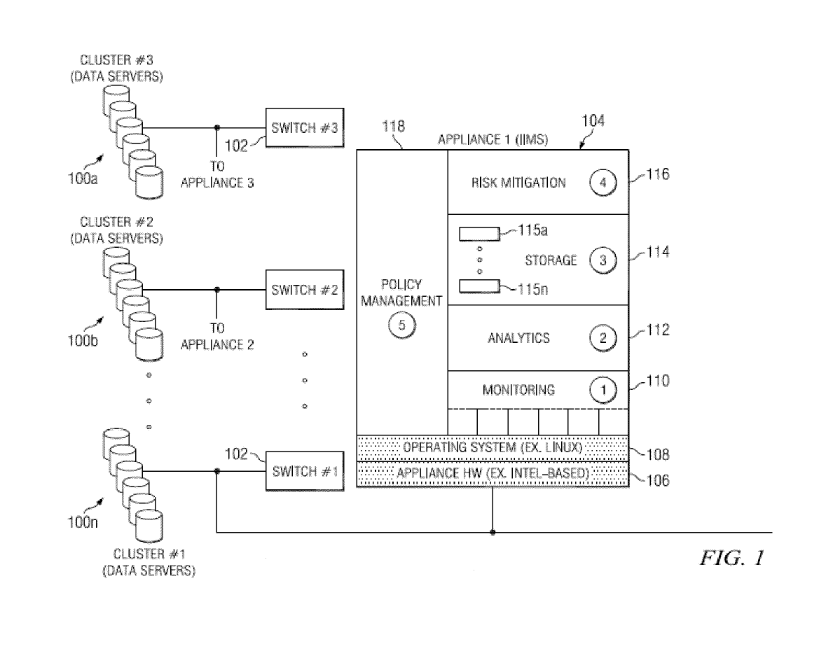

One such enterprise environment is illustrated in FIG. 1 and includes one or more clusters 100a-n of data servers connected to one or more switches 102a-n. Although not meant to be limiting, a given data server is a database, a file server, an application server, or the like, as the present invention is designed to be compatible with any enterprise system, machine, device or other entity from which a given data access can be carried out. A given cluster 100 is connected to the remainder of the distributed environment through a given switch 102, although this is not a limitation of the enterprise environment. In this illustrative embodiment, a “client” appliance is implemented by a network-based appliance 104 that preferably sits between a given switch 102 and a given cluster 100 to provide real-time monitoring, auditing and protection of information assets in a cluster associated with that client.

As also illustrated in FIG. 1, the appliance 104 is a machine running commodity (e.g., Pentium-class) hardware 106, an operating system (e.g., Linux, Windows 2000 or XP, OS-X, or the like) 108, and having a set of functional modules: a monitoring module or layer 110, an analytics module or layer 112, a storage module or layer 114, a risk mitigation module or layer 116, and a policy management module or layer 118. These modules preferably are implemented a set of applications or processes (e.g., linkable libraries, native code, or the like, depending on platform) that provide the functionality described below. More generally, unless indicated otherwise, all functions described herein may be performed in either hardware or software, or any combination thereof. In an illustrated embodiment, the functions are performed by one or more processors executing given software. The functions of the various modules as described below may be implemented in fewer than the modules disclosed or in an integrated manner, or through a central management console. Although not illustrated in detail, typically the appliance 104 also includes an application runtime environment (e.g., Java), a browser or other rendering engine, input/output devices and network connectivity. The appliance 104 may be implemented to function as a standalone product, to work cooperatively with other such appliances while centrally managed or configured within the enterprise, or to be managed remotely, perhaps as a managed service offering.

In the illustrated embodiment, the network appliance monitors the traffic between a given switch and a given cluster to determine whether a given administrator- (or system-) defined insider attack has occurred. As used herein, the phrases “insider intrusions,” “access intrusion,” “disclosure violations,” “illegitimate access” and the like are used interchangeably to describe any and all disclosure-, integrity- and availability-related attacks on data repositories carried out by trusted roles. As is well-known, such attacks can result in unauthorized or illegitimate disclosures, or in the compromise of data integrity, or in denial of service. As already noted, the nature and type of data repositories that can be protected by the appliance include a wide variety of devices and systems including databases and database servers, file servers, web servers, application servers, other document servers, and the like (collectively, “enterprise data servers” or “data servers”). This definition also includes directories, such as LDAP directories, which are often used to store sensitive information.

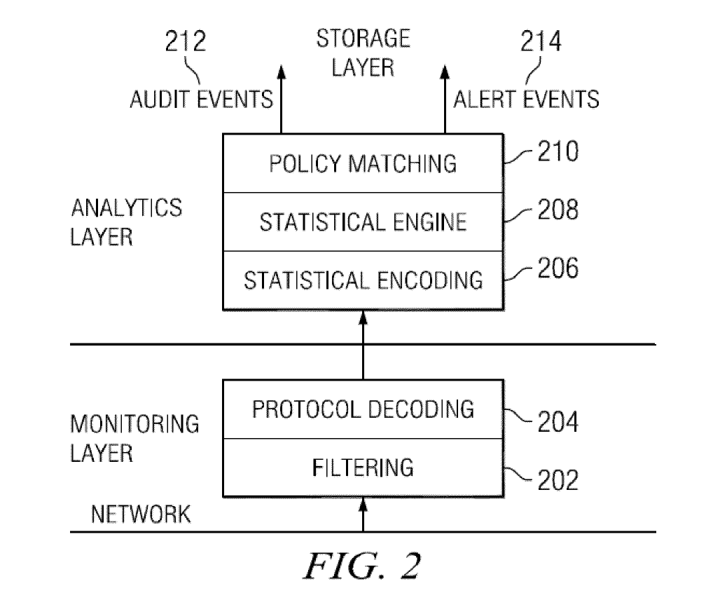

Referring now back to FIG. 1, the first module 110 (called the monitoring layer) preferably comprises a protocol decoding layer that operates promiscuously. The protocol decoding layer typically has specific filters and decoders for each type of transactional data server whether the data server is a database of a specific vendor (e.g., Oracle versus Microsoft SQL Server) or a file server or an application server. In general, the protocol decoding layer filters and decoders extend to any type of data server to provide a universal “plug-n-play” data server support. The operation of the layer preferably follows a two-step process as illustrated in FIG. 2: filtering and decoding. In particular, a filtering layer 202 first filters network traffic, e.g., based on network-, transport-, and session-level information specific to each type of data server. For instance, in the case of an Oracle database, the filter is intelligent enough to understand session-level connection of the database server and to do session-level de-multiplexing for all queries by a single user (client) to the user. In this example, only network traffic that is destined for a specific data server is filtered through the layer, while the remaining traffic is discarded. The output of the filtering preferably is a set of data that describes the information exchange of a session along with the user identity. The second function of the monitoring layer is to decode the (for example) session-level information contained in the data server access messages. In this function 204, the monitoring layer parses the particular access protocol, for example, to identify key access commands of access. Continuing with the above example, with Oracle data servers that use SQLNet or Net8 as the access protocol, the protocol decoding layer is able to decode this protocol and identity key operations (e.g., SELECT foo from bar) between the database client and server. This function may also incorporate specific actions to be taken in the event session-level information is fragmented across multiple packets. The output of function 204 is the set of access commands intended on the specific data server.

The monitoring layer may act in other than a promiscuous mode of operation. Thus, for example, given traffic to or from a given enterprise data server may be encrypted or otherwise protected. In such case, it may be desirable to include in the monitoring layer additional code (e.g., an agent) that can be provisioned to receive and process (through the filtering and decoding steps) data feeds from other sources, such as an externally-generated log.

The monitoring layer advantageously understands the semantics of the one or more data access protocols that are used by the protected enterprise data servers. As will be described in more detail below, the policy management layer 118 implements a policy specification language that is extremely flexible in that it can support the provisioning of the inventive technique across many different kinds of data servers, including data servers that use different access protocols. Thus, for example, the policy language enables the administrator to provision policy filters (as will described) that process functionally similar operations (e.g., a “READ” Operation with respect to a file server and a “SELECT” Operation with respect to a SQL database server) even though the operations rely on different access protocols. Because the policy management layer 118 supports this flexibility, the monitoring layer 110 must likewise have the capability to understand the semantics of multiple different types of underlying data access protocols. In addition, the monitoring layer can monitor not only for content patterns, but it can also monitor for more sophisticated data constructs that are referred to herein (and as defined by the policy language) as “containers.” “Containers” typically refer to addresses where information assets are stored, such as table/column containers in a database, or file/folder containers in a file server. Content “patterns” refer to specific information strings. By permitting use of both these constructs, the policy language provides significant advantages, e.g., the efficient construction of compliance regulations with the fewest possible rules. The monitoring layer 118 understands the semantics of the underlying data access protocols (in other words, the context of the traffic being monitored); thus, it can enforce (or facilitate the enforcement of) such policy.

The second module 112 (called the analytics layer) implements a set of functions that match the access commands to attack policies defined by the policy management layer 118 and, in response, to generate events, typically audit events and alert events. An alert event is mitigated by one or more techniques under the control of the mitigation layer 116, as will be described in more detail below. The analytics are sometimes collectively referred to as “behavioral fingerprinting,” which is a shorthand reference that pertains collectively to the algorithms that characterize the behavior of a user's information access and determine any significant deviations from it to infer theft or other proscribed activities.

With reference again to FIG. 2, a statistical encoding function 206 translates each access operative into a compact, reversible representation. This representation preferably is guided by a compact and powerful (preferably English-based) policy language grammar. This grammar comprises a set of constructs and syntactical elements that an administrator may use to define (via a simple GUI menu) a given insider attack against which a defense is desired to be mounted. In an illustrative embodiment, the grammar comprises a set of data access properties or “dimensions,” a set of one or more behavioral attributes, a set of comparison operators, and a set of expressions. A given dimension typically specifies a given data access property such as (for example): “Location,” “Time,” “Content,” “Operation,” “Size,” “Access” or “User.” A given dimension may also include a given sub-dimension, such as Location.Hostname, Time.Hour, Content.Table, Operation.Select, Access.Failure, User.Name, and the like. A behavioral attribute as used herein typically is a mathematical function that is evaluated on a dimension of a specific data access and returns a TRUE or FALSE indication as a result of that evaluation. A convenient set of behavior attributes thus may include (for example): “Rare,” “New,” “Large,” High Frequency” or “Unusual,” with each being defined by a given mathematical function. The grammar may then define a given “attribute (dimension)” such as Large (Size) or Rare (Content.Table), which construct is then useful in a given policy filter. For additional flexibility, the grammar may also include comparison operators to enable the administrator to define specific patterns or conditions against which to test, such as Content.Table is “Finance” or Time.Hour=20. Logical operators, such as AND, OR and the like, can then be used to build more complex attack expressions as will seen below.

A given attack expression developed using the policy management layer is sometimes referred to as a policy filter. As seen in FIG. 2, the analytics layer preferably also includes a statistical engine 208 that develops an updated statistical distribution of given accesses to a given data server (or cluster) being monitored. A policy matching function 210 then compares the encoded representations to a set of such policy filters defined by the policy management layer to determine if the representations meet the criteria set by each of the configured policies. By using the above-described grammar, policies allow criteria to be defined via signatures (patterns) or anomalies. As will be seen, anomalies can be statistical in nature or deterministic. If either signatures or anomalies are triggered, the access is classified as an event; depending on the value of a policy-driven response field, an Audit 212 and/or an Alert 214 event is generated. Audit events 212 typically are stored within the appliance (in the storage layer 114), whereas Alert events 214 typically generate real-time alerts to be escalated to administrators. Preferably, these alerts cause the mitigation layer 116 to implement one of a suite of mitigation methods.

The third module 114 (called the storage layer) preferably comprises a multi-step process to store audit events into an embedded database on the appliance. To be able to store with high performance, the event information preferably is first written into memory-mapped file caches 115a-n. Preferably, these caches are organized in a given manner, e.g., one for each database table. Periodically, a separate cache import process 117 invokes a database utility to import the event information in batches into the database tables.

The fourth module 116 (called the risk mitigation layer) allows for flexible actions to be taken in the event alert events are generated in the analytics layer. As will be described in more detail below, among the actions preferably supported by this module are user interrogation and validation, user disconnection, and user de-provisioning, which actions may occur synchronously or asynchronously, or sequence or otherwise. In a first mitigation method, the layer provides for direct or indirect user interrogation and/or validation. This technique is particularly useful, for example, when users from suspicious locations initiate intrusions and validation can ascertain if they are legitimate. If an insider intrusion is positively verified, the system then can perform a user disconnect, such as a network-level connection termination. If additional protection is required, a further mitigation technique then “de-provisions” the user. This may include, for example, user deactivation via directories and authorization, and/or user de-provisioning via identity and access management. Thus, for example, if an insider intrusion is positively verified, the system can directly or indirectly modify the authorization information within centralized authorization databases or directly modify application authorization information to perform de-provisioning of user privileges. The mitigation layer may provide other responses as well including, without limitation, real-time forensics for escalation, alert management via external event management (SIM, SEM), event correlation, perimeter control changes (e.g., in firewalls, gateways, IPS, VPNs, and the like) and/or network routing changes.

Thus, for example, the mitigation layer may quarantine a given user whose data access is suspect (or if there is a breach) by any form of network re-routing, e.g, VLAN re-routing. Alternatively, the mitigation layer (or other device or system under its control) undertakes a real-time forensic evaluation that examines a history of relevant data accesses by the particular user whose actions triggered the alert. Forensic analysis is a method wherein a history of a user's relevant data accesses providing for root-cause of breach is made available for escalation and alert. This reduces investigation time, and forensic analysis may be used to facilitate which type of additional mitigation action (e.g., verification, disconnection, de-provisioning, some combination, and so forth) should be taken in the given circumstance.

As has already been described, the fifth module 118 (called the policy management layer) interacts with all the other layers. This layer allows administrators to specify auditing and theft rules, preferably via an English-like language. The language is used to define policy filters (and, in particular, given attack expressions) that capture insider intrusions in an expressive, succinct manner. The language is unique in the sense it can capture signatures as well as behavioral anomalies to enable the enterprise to monitor and catch “insider intrusions,” “access intrusions,” “disclosure violations,” “illegitimate accesses” “identity thefts” and the like regardless of where and how the given information assets are being managed and stored within or across the enterprise.

A given appliance may be operated in other than promiscuous mode. In particular, the monitoring layer (or other discrete functionality in the appliance) can be provided to receive and process external data feeds (such as a log of prior access activity) in addition to (or in lieu of) promiscuous or other live traffic monitoring.

A given function in the appliance may be implemented across multiple such appliances, or under the control of a management console.

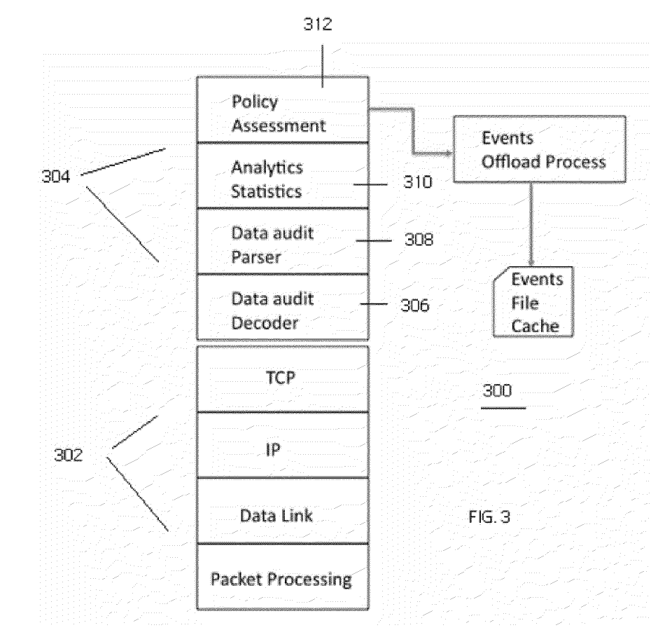

Referring now to FIG. 3, a typical data auditing “fast path” 300 is shown. The lower half of the fast path is comprised of traditional TCP-IP packet processing 302. The upper half 304 of the fast path is the data auditing stack which in turn includes four modules—the lower data auditing stack (data auditing decoder 306, data auditing parser 308), and upper data auditing stack (analytics statistics 310, policy assessment 312). In comparing FIG. 3 with FIG. 2 described earlier, the filtering layer 202 corresponds to the TCP/IP packet processing 302, the protocol decoding function 204 corresponds to the data auditing decoding 306, the statistical encoding function 206 corresponds to the data auditing parser 308, the statistical engine 208 corresponds to the analytics statistics parser 310, and the policy matching 210 corresponds to the policy assessment 312. The following are the definitions of each data auditing layer:

Data auditing decoder—This layer decodes the specific application wrappers surrounding application messages and collects the transaction-level messages.

Data auditing parser—This layer parses the specific session message into behavioral dimensions of access activity, such as content, user, time, location, operation etc.

Analytics statistics—The analytics statistics layer creates numerous statistical counters that keep track of user-level behavior across different dimensions. For example, if a user has repeated a “select” command on a database, a counter can be incremented to keep track of this.

Policy Assessment—The policy assessment layer evaluates each activity against policies that are set up in advance. Policies could have signatures (deterministic value matches), patterns, or anomalies.

In a traditional data auditing fast path such as shown in FIG. 3, the TCP-IP packet processing stack 302 typically is parallelized, but this not the case for the data auditing stack. This means that two concurrent sessions cannot utilize the data auditing stack at the same time. A traditional fast path (once active) would block any subsequent session until it has completed execution—thus leading to 8x units of time for the subsequent session. As the number of concurrent sessions increase and the number of activity dimensions increase, the serial fast path may demonstrate serious scaling and throughput issues. Particularly, as data auditing applications evolve from basic policies (such as signature matches) to complex anomaly policies (for risk management), the upper layers of the data auditing stack are likely to dominate execution time, further worsening the throughput.

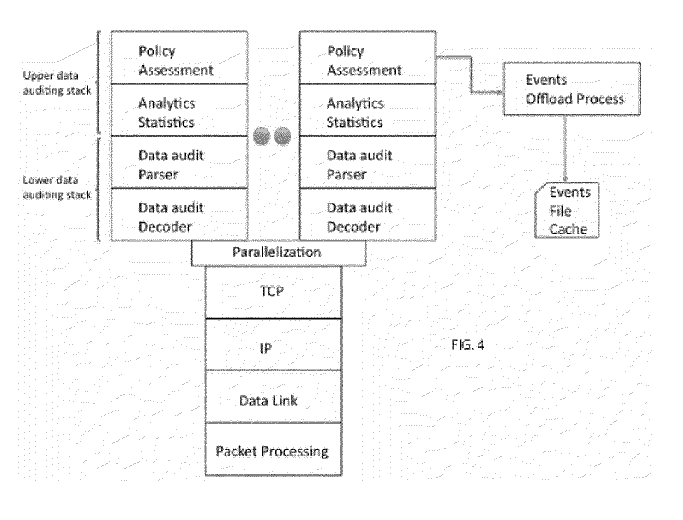

This disclosure addresses this problem by parallelizing data auditing stack in addition to packet processing. FIG. 4 below represents an illustration of the new data auditing fast path. Within the data auditing stack, the current invention parallelizes individual modules depending on the extent of parallelism possible. The implication of this parallelism is that the fast path speeds-up the overall throughput of data auditing. For example, if each module in the data auditing stack costs “x” units of time, a fully parallelized data auditing stack completes in 4x units of time. As noted above, the subject invention contemplates parallel computation of one or more of the upper data auditing stack (modules 208 and 210) and/or one or more of the lower data auditing stack (modules 204 and 206). The parallel processing typically is done across sessions, although it may also be done on a per-user basis.

More generally, although the appliance has been described in the context of a method or process, the present invention also relates to apparatus for performing the operations herein. As described above, this apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including an optical disk, a CD-ROM, a magnetic-optical disk, a read-only memory (ROM), a random access memory (RAM), a magnetic or optical card, or any type of media suitable for storing electronic instructions, and each coupled to a computer system bus.

What is claimed is as follows:

1. Apparatus for protecting an enterprise data server against insider attack, comprising:
a processor;
computer memory holding a first code module that when executed on the processor analyzes a trusted user's given data access against a set of one or more configurable policy filters; and
the computer memory holding a second code module that when executed by the processor determines whether the trusted user's data access is indicative of an action specified by a policy filter in the set of policy filters;
wherein multiple instances of at least one of the first or second code modules are executed in parallel.

2. The apparatus as described in claim 1 wherein the multiple instances are processed across sessions.
